(19) United States
(12) Patent Application Publication
(10) Pub. No.: US 2013/0049261 A1
(43) Pub. Date: Feb. 28, 2013

(54) METHOD AND DEVICE FOR STAMPING MARKINGS, IN PARTICULAR MOTOR VEHICLE MARKINGS

(71) Applicant: Koert J.W. Kirpestein, Geldermalsen (NL)

(72) Inventor: Koert J.W. Kirpestein, Geldermalsen (NL)

(73) Assignee: J.H. Tonnjes E.A.S.T. GmbH & Co. KG, Delmenhorst (DE)

(21) Appl. No.: 13/580,717

(22) PCT Filed: Dec. 24, 2010
(86) PCT No.: PCT/EP2010/007943

§ 371 Date: Sep. 26, 2012

(30) Foreign Application Priority Data
Feb. 26, 2010 (DE) 10 2010 009 555.9
Jun. 10, 2010 (DE) 10 2010 023 254.8

(51) Int. Cl. B29C 59/02

(52) U.S. Cl. 264/320; 425/394

(57) ABSTRACT

A method and apparatus for the use of a handling device, which is preferably configured as a data robot, in order to assemble embossing tools for embossing the desired character sequence into a blank. The handling device preferably also serves to position the respective blank in front of the embossing tools assembled in accordance with the desired character sequence and/or to center or orient the embossing tools with respect to the blank. The method and apparatus can be used in connection with the production of motor vehicle license plates in which an individual character sequence is embossed into a blank.

The invention relates to a method for producing in particular motor vehicle license plates according to the preamble of claim 1. Furthermore, the invention relates to an apparatus for producing in particular motor vehicle license plates according to the preamble of claim 7.

Identification plates, specifically in particular motor vehicle license plates, have an individual character sequence consisting of letters and/or numbers. The number and order of the letters and/or numbers is determined in each case in a country-specific manner and is thus different. Usually, the motor vehicle license plates consist of both characters and numbers in a particular order. There are also states in which the motor vehicle license plates have only characters or numbers. There are other states which do not authorize all of the letters of the alphabet, but only a selection of particular letters, for motor vehicle license plates. The same can also apply for numbers.

The succession of letters and/or numbers (always called “character sequence” in the following text) provided for individual identification plates is embossed into a blank in the case of identification plates of the type discussed here. The blank is generally a still flat pre-cut part made of thin sheet metal, for example aluminum, a thin-walled plastics plate or the like. The blank can also optionally already be provided with embossed features which occur repeatedly, for example an embossed encircling edge or particular combinations of letters and/or numbers which are always the same for a relatively large number of identification plates. The individual character set is embossed into the as yet unembossed or pre-embossed blanks by embossing tools. Each embossing tool consists of a top part, in which the respective character is incorporated in a recessed manner, and a bottom part, from which the same character protrudes. The top part and bottom part of the embossing tool are connected in a hinge-like manner at a transverse edge. This results in a mouth-like embossing tool which is open at one transverse edge and into which the blank can be introduced transversely to its longitudinal direction.

A corresponding stock of the necessary characters (numbers and/or letters) is stored in a magazine. The characters required for individually embossing the respective identification plate are removed from the magazine and arranged in a tool holder to form the desired character set. This is very time-consuming.

The invention is based on the object of creating a method and an apparatus for producing embossed identification plates, in particular motor vehicle license plates, said method and apparatus operating at least largely automatically.

A method for achieving this object has the features of claim 1. According thereto, it is provided that the embossing tools that are required for the identification plate in each case to be embossed are removed from a magazine and positioned on or in a tool holder by a handling device in the sequence provided. Hitherto, the picking out of the required embossing tools from the magazine and the arrangement of the embossing tools in the correct order on or in the tool carrier represented the most complicated activities for the production of identification plates. These activities take place automatically in the method according to the invention by way of the handling device which operates in the manner of a robot. The handling device not only mechanically transfers the required embossing tools from the magazine to the tool holder, it can use a corresponding controller to pick out the embossing tools in the intended order from the magazine and position them on or in the tool holder.

One advantageous embodiment of the method provides that the embossing tools are positioned and preferably oriented by the handling device on or in the tool holder in the desired relative position with respect to the blank, in particular in a computationally determined relative position with respect to the blank. This ensures that, in the case of fonts having characters of different widths and equal spaces between the adjacent characters, the handling device can position embossing tools of different widths on the tool holder in a centered manner with respect to the blank or the embossing tools are distributed over the width of the blank such that the characters are distributed regularly over the width of the blank. The handling device can also deposit the embossing tools in such a computationally determined relative position on or in the tool holder that two-line identification plates can be embossed. Alternatively or in addition, it is also conceivable to position the blank automatically in the desired position with respect to the embossing tools.

The method according to the invention is preferably configured in such a way that in each case one blank is removed by the handling device from a store having a large number of blanks that are preferably located one above another, and is automatically positioned next to the tool holder such that the blank is oriented in the tool holder at least in its longitudinal direction in relation to the individually assembled embossing tools. As a result, the desired positions at which the characters are intended to be embossed into the blank by the embossing tools are determined by the robot-like handling device, in particular the automatic controller thereof.

A preferred development of the invention provides for the respective blank to be introduced by a transporting device into the embossing tool assigned to the tool holder. Once the blank has been positioned by the handling device in the position, next to the tool holder having the embossing tools, in which the characters are intended to be embossed into the blank by the embossing tools, the transporting device only needs to introduce the blank in a straight line into the open mouths of the embossing tools.

An alternative method provides for the respective blank to be deposited by the handling device at a particular location next to the tool holder, wherein this location can be determined if appropriate by at least one stop, and for the blank to be oriented with respect to the embossing tools in the tool holder by the transporting device or some other device that permits the blank to be displaced in the longitudinal direction. The adjusting movements of this device can be carried out by the same controller as is used to control the handling device.

According to an advantageous configuration of the method, it is provided that the tool holder having the blank inserted into the embossing tool is transported into an embossing press and after embossing transported out again by the transporting device. This also dispenses with manual activities for this step of producing the identification plate.

An apparatus for achieving the object mentioned at the beginning has the features of claim 7. This apparatus is distinguished by a handling device which serves at least to place the embossing tools, which are required for embossing each individual identification plate, on the tool holder. The handling device automatically picks out one by one the required embossing tools from the magazine and transfers them in the correct order to the tool holder, where the handling device sets down the embossing tools at the same time at the intended position. The embossing tools can be removed automatically from the magazine by the handling device in the order of the characters on the identification plate to be produced, and positioned at the correct location on or in the tool holder. Advantageously, the handling device is configured as a robot which serves in particular as a centering unit.

A handling device which is configured in a preferred manner according to the invention has a multiaxially movable grasping means. The grasping means can be grippers, suction cups or else magnets, which are suitable for grasping and retaining at least in each case one selected embossing tool and/or a blank for producing the identification plate, in order to transport the embossing tool or the blank to the desired location and to set it down there. On account of the fact that the grasping means is multiaxially movable, it can spatially reorient the respective embossing tool or the blank, as a result of which the magazine for the embossing tools, the store for the blanks and the tool holder can be located not only at different locations in the apparatus but also at different heights, which can be changed if appropriate, as is the case for example in the case of blanks that are stacked one above another in the store.

According to a further advantageous configuration of the invention, the handling device is provided with a plurality of, preferably three, arms that are in each case movable about a rotation axis and represent the centering units. The arms preferably form parallelograms. The handling device which is configured in this way and is also known as a delta robot always keeps the grasping means in the same orientation at all conceivable positions in a spatial, three-dimensional region. As a result, the grasping means can take hold of an embossing tool or a blank in the same direction and set the embossing tool or the blank down at a different location without tilting or pivoting. However, it is also conceivable for the grasping means to be arranged on the handling device such that, while maintaining the direction, it can perform other movements, in particular rotary movements, in a targeted manner in order, for example, to rotate the blank and/or the embossing tool from the position in the store or in the magazine into another position which the embossing means or the blank is intended to take up in the tool holder or next to the latter.

A development of the apparatus provides for a blank holder for a blank to be provided next to or in front of the respective tool holder. The blank holder is assigned to the handling device such that in each case one blank can be deposited on the blank holder by the handling device. Therefore, the handling device serves not only to deposit the embossing tools on the tool holder but also to deposit a blank of the identification plate to be embossed in front of or next to the tool holder. The handling device thus has a plurality of functions.

The invention further provides for the at least one stop to be assigned to each blank holder, said stop serving to position and/or orient the respective blank on the blank holder. In particular, as a result, the blank is deposited on or in the tool holder on the table-like blank holder in a defined relative position with respect to the embossing tools. As a result, when the blank is deposited on the blank holder it is simultaneously oriented in the desired or necessary relative position with respect to the embossing tools. Alternatively or in addition, it is also conceivable to assign at least one stop to the embossing tools.

A further advantageous configuration of the apparatus provides for the respective blank holder to be configured to displace the blank lying thereon in the longitudinal direction, i.e. transversely to the embossing tools on the tool holder. As a result, the blank can be centered in relation to the embossing tools, depending on the position and size of the character sequence to be embossed in each case into the blank. This displacement, serving for centering, of the blank takes place in a manner controlled in a targeted manner by the blank holder, specifically preferably by way of signals from the controller of the handling device and/or transporting device.

A preferred exemplary embodiment of the invention is explained in more detail in the following text by way of the drawing, in which:

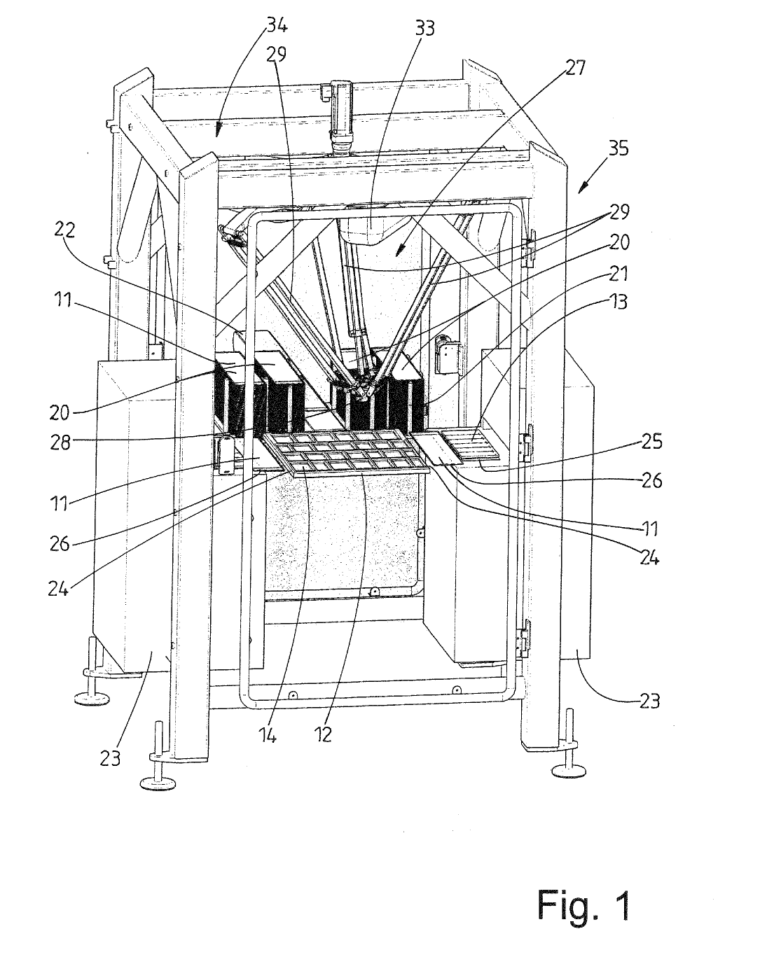

FIG. 1 shows a perspective view of an apparatus obliquely from the front,

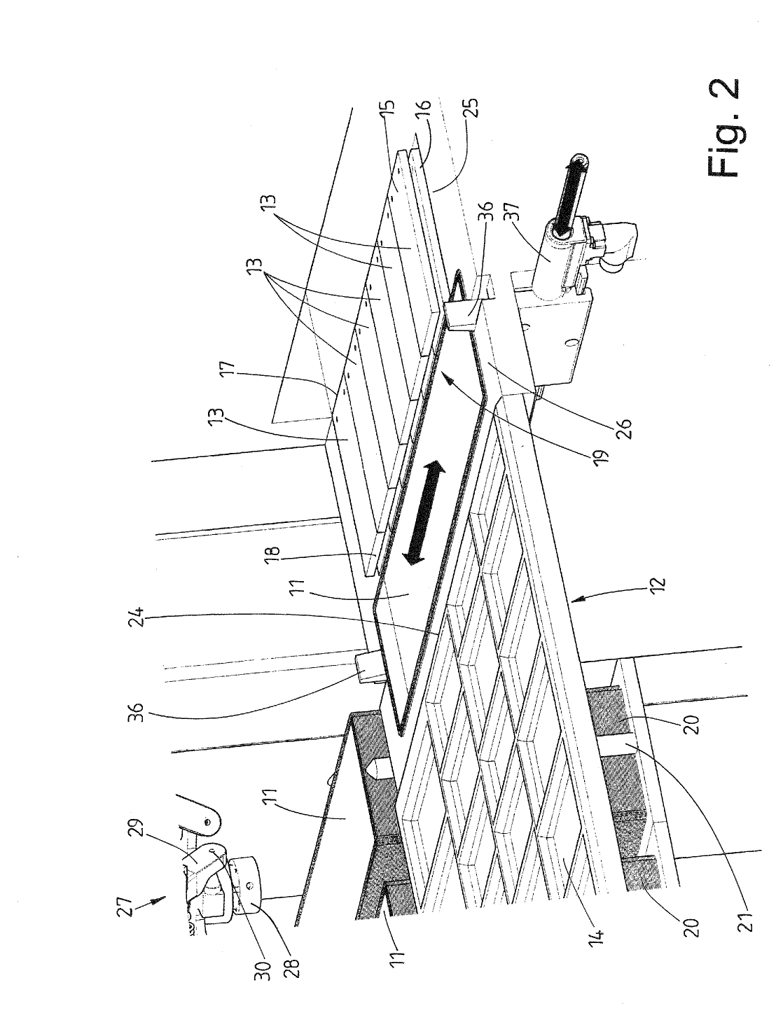

FIG. 2 shows an enlarged detail of the apparatus from FIG. 1,

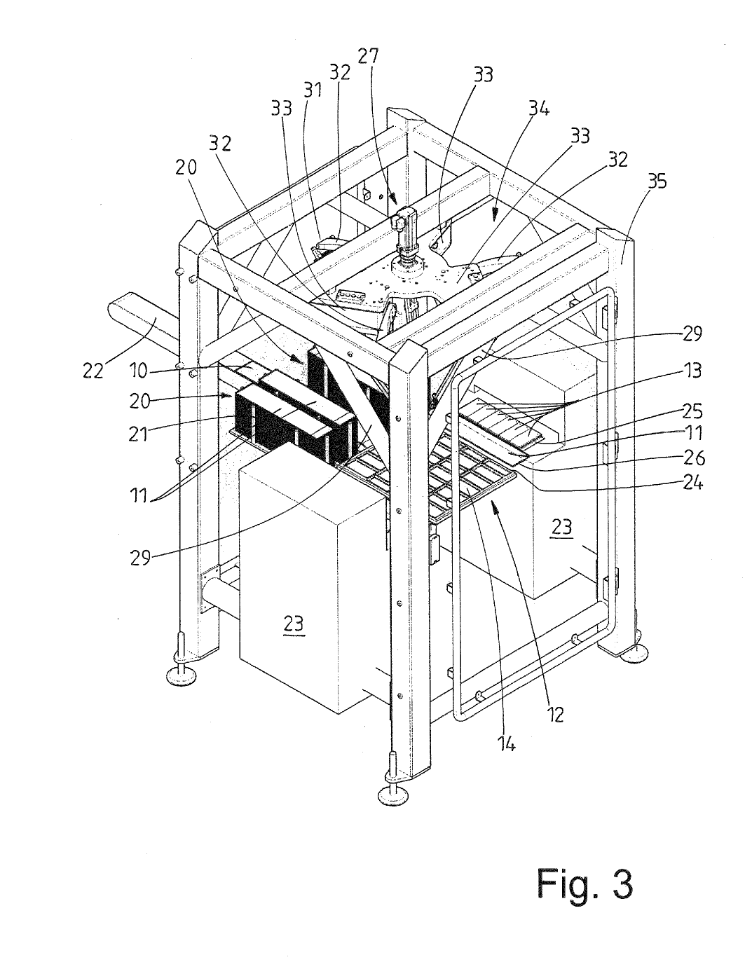

FIG. 3 shows a perspective view of the apparatus obliquely from the front, specifically from a different viewing angle,

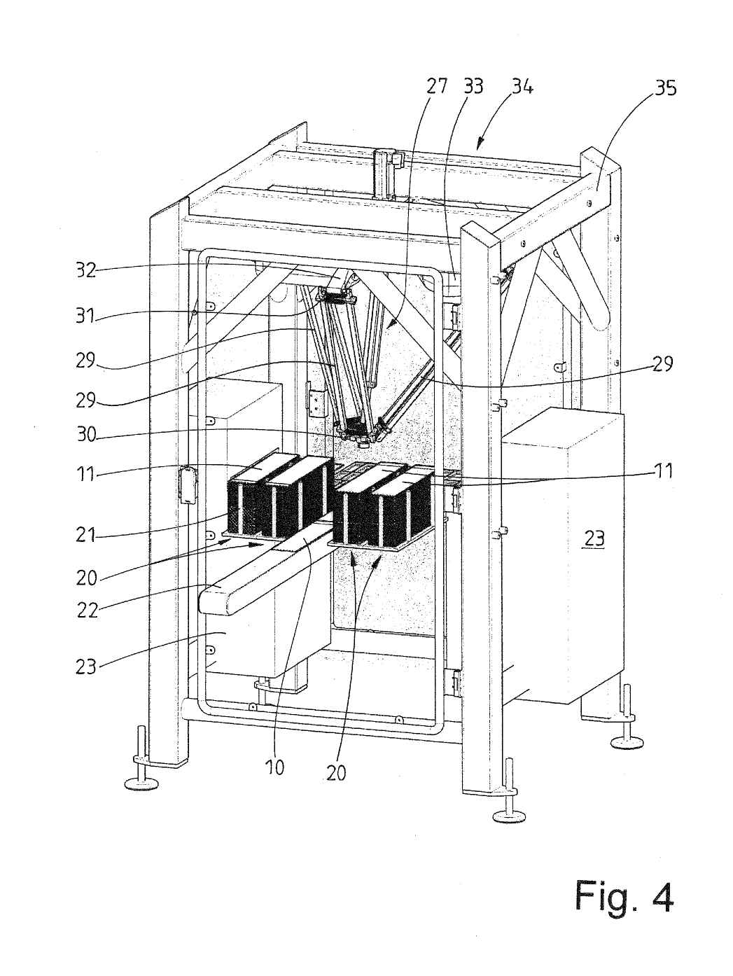

FIG. 4 shows a perspective view of the apparatus obliquely from the rear, and

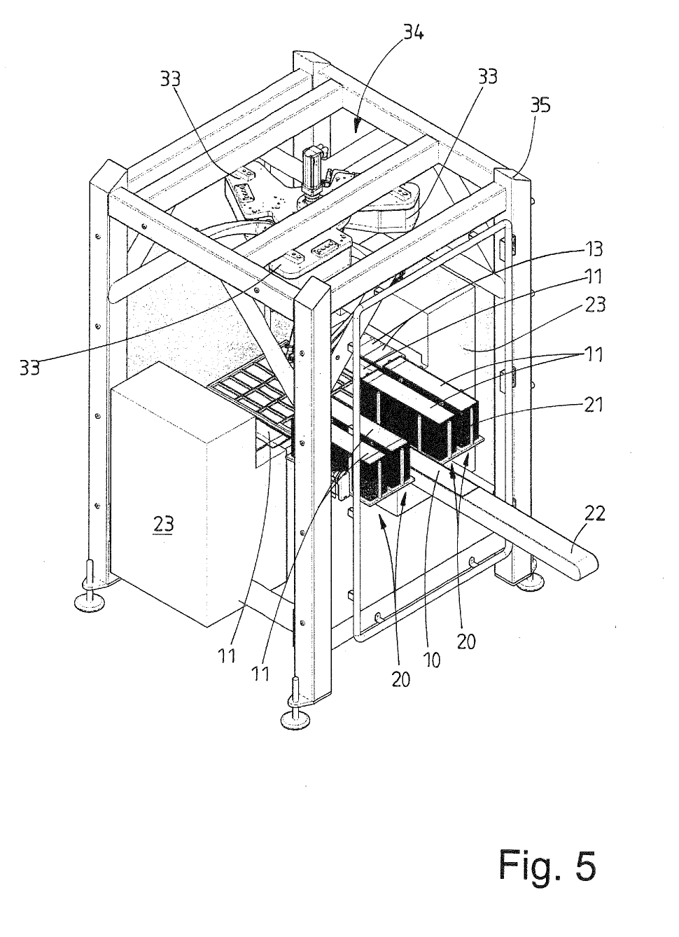

FIG. 5 shows a view of the apparatus from the rear at a different viewing angle, specifically obliquely from above.

The apparatus shown serves to produce motor vehicle license plates 10, specifically to emboss an individual character sequence and optionally also symbols into a blank 11 for the motor vehicle license plate 10. In the apparatus shown here, only the individual character sequence and optionally symbols are embossed into the blanks 11. However, the blank 11 may already have been pre-embossed, for example with an embossed encircling edge and/or repeating letters, figures and/or symbols. The blank 11 consists of sheet steel or aluminum or also optionally of a plastics plate or sheet. While the blank 11 made of steel or aluminum is embossed cold, a blank 11 made of plastics material is embossed in the heated state.

The apparatus shown has a magazine 12 which contains all the required embossing tools 13. The magazine 12 is configured as a flat-surfaced tray having holders 14, arranged alongside one another and one above another, for in each case a single embossing tool 13 or else a plurality of embossing tools 13 located one above another. The magazine 12 has a number of holders 14 which corresponds to the number of different embossing tools 13. The magazine 12 shown in the figures has only 27 holders 14. In some states, not all of the letters of the alphabet are used for motor vehicle license plates 10, and so the number of holders 14 shown can be sufficient in such states. If necessary, the magazine 14 can have a larger number of holders 14, specifically where appropriate a number of holders 14 corresponding to all of the letters of the alphabet, all of the numbers and the symbols used. A plurality of embossing tools 13 stacked one above another can be located in a holder 14. These are preferably identical embossing tools, i.e. those for the same character or the same symbol. However, it is also conceivable for different embossing tools 13 to be stacked one above another in a holder 14. In such a case, the position of each individual embossing tool 13 in the magazine 12 is stored in a memory of a controller. In the magazine 12 shown in the figures, the holders 14 are different sizes. They correspond to the size of the embossing tools 13, which can vary in particular for letters. For example, the embossing tools 13 for an “I” are narrower than for a “W”. With embossing tools 13 that are the same width, all of the holders 14 in the magazine 12 can be the same size.

The embossing tools 13 which are illustrated only symbolically in FIG. 2 are configured in a mouth-like manner. In addition, each in principle identical embossing tool 13 consists of a top part, in which in each case one character or symbol is incorporated in a recessed manner in order to emboss the top side of the motor vehicle license plate 10, and a bottom part 16, from which the character or symbol corresponding to the top side 15 protrudes in order to emboss the underside of the motor vehicle license plate 10. The top part 15 and the bottom part 16 of each embossing tool 13 are connected together in a hinge-like manner at adjacent transverse edges 17. At the opposite transverse edges there is no connection between the bottom part 16 and the top part 15, and so an open mouth 19 is present at the transverse edges 18 of the top part 15 and the bottom part 16 of each embossing tool 13. As a result, the blank 11 can be introduced into the embossing tools 13 transversely to its longitudinal axis.

With regard to FIGS. 1 to 3, a plurality of preferably same-sized stores 20 for a stock of blanks 11 are provided behind the magazine 12. In the exemplary embodiment shown, two stores 20, which are located alongside one another, are arranged behind the magazine on both sides of a center of the apparatus. Each store 20 is configured such that a plurality of blanks 11 that are stacked one above another are accommodated therein. The blanks 11 of each stack are guided laterally against displacement in the store 20 by upright retaining rods 21. At the top, each store 20 is open for the removal of the respectively top-most blank of the stack from the respective store 20. The apparatus can also have a larger or smaller number of stores 20 than is shown in the figures.

The two stores 20 on each side of the apparatus are spaced so far apart from one another that room for a removal conveyor 22 arises between them. The horizontally extending removal conveyor 22 extends centrally in the longitudinal direction through the apparatus, specifically starting from the rear side of the magazine 12.

The apparatus shown has two, preferably identically configured embossing presses 23. However, the invention is not restricted thereto. The apparatus can have more than two embossing presses 23, but also only a single embossing press 23. The embossing presses 23 are assigned to opposite sides of the apparatus, with the magazine 12 being located approximately centrally between the two embossing presses 23. The embossing presses 23 are arranged in a mirror-inverted manner with respect to one another, so that they can be loaded, starting from the magazine 12 arranged approximately centrally in the apparatus, via opposite transverse sides 23 of the magazine 12.

Each embossing press 23 is assigned a tool holder 25 for embossing tools 13 that are required for embossing the respective motor vehicle license plate 10, and a table-like blank holder 26 for in each case one blank 11. Located on the outside next to each transverse side 24 of the magazine 12 there is in each case one blank holder 26, and next to the latter, i.e. between the respective blank holder 26 and an embossing press 23, there is the tool holder 25. In the apparatus shown here, the magazine 12, the blank holder 26 and the tool holders 25 arranged laterally alongside the latter are located approximately in a horizontal plane between the two opposite embossing presses 23.

The apparatus furthermore has a handling device 27 which is configured in the manner of a robot. In the exemplary embodiment shown, the handling device 27 is formed as what is known as a delta robot. The latter has a spatially movable grasping means 28. The grasping means 28 can be moved at least triaxially in three-dimensional space by the handling device 27. The grasping means 28 is configured such that it can grasp both blanks 11 and embossing tools 13. For this purpose, the grasping means 28 can be configured as a suction gripper. Alternatively, the grasping means 28 can also be formed by a mechanical gripper or a magnet. Preferably, the grasping means 28 is rotatable about at least one center axis, specifically in particular about a vertical center axis. As a result, the blanks 11 and/or embossing tools can be rotated, this being necessary in the apparatus shown here with two embossing presses 23 offset through 180° with respect to one another.

The handling device 27 shown and configured as a delta robot has three identically configured arms, which in this case are parallelogram arms 29 that are mounted on the grasping means 28 in an articulated manner via rotation axes 30 by way of lower ends. The three parallelogram arms 29 that are configured as centering units are arranged regularly around the grasping means 28, i.e. offset in each case by 120° with respect to one another.

An upper end of each parallelogram arm 29 is mounted at a free end of a pivot arm 32 such as to be rotatable about a rotation axis 31. An opposite end, facing toward the middle of the apparatus, of the pivot arm 32 is secured to a rotary drive 33. The rotation axes 30, 31 at opposite ends of all parallelogram arms 29 extend horizontally and parallel to one another, wherein the rotation axes 30 at the lower ends of the parallelogram arms 29 are arranged tangentially around in each case one imaginary circular path around the grasping means 28. The rotation axes 31 at the upper ends of the parallelogram arms 29 are likewise arranged tangentially in a manner offset by 120° to one another on a circular path which, however, is larger than the circular path on which the lower rotation axes 30 lie. As a result, the handling device 27 configured as a delta robot has a configuration in the manner of a collapsible umbrella. The three rotary drives 33 for in each case one parallelogram arm 29 are arranged in a fixed manner under a ceiling plane 34 of a three-dimensional frame 35 of the apparatus. The frame 35 also supports the magazine 12, the holder 14, the store 20 and the removal conveyor 22. The embossing presses 23 can also be mounted on the frame 35 or at least be secured to the frame 35 so as to be immovable in relation thereto. However, it is also conceivable to arrange the embossing presses 23 independently on opposite sides of the frame 35.

The rotary drives 33 are arranged in a manner distributed regularly on a circular path around the center point of the ceiling plane 34. As a result, the pivot arms 32 of the rotary drives 33 move in vertical planes which extend in a manner offset radially through 120° with respect to the center point of the ceiling plane 34. The actuation of a single rotary drive 33 or a coordinated movement of two or even all three rotary drives 33 and a superposed movement, resulting therefrom, of the pivot arms 32 having the parallelogram arms 29 leads to a desired movement of the grasping means 28 to a particular point in (three-dimensional) space, wherein the center axis of the grasping means 28 always retains its preferably vertical orientation.

According to the illustration in FIG. 2, the blank holder 26 is provided with two stops 36 assigned to opposite short transverse edges of the blank 11. The stops 36 have such a spacing that a blank 11 can be held between them in a substantially immovable manner in the longitudinal direction. The two stops 36 are movable by a linear drive 37, which may be for example a pneumatic cylinder, and specifically together at an unaltered spacing (double arrow in FIG. 2) in order to center the blank 11 in front of the tool holder 25, on which the embossing tools 13 are arranged, and also individually for adaptation to blanks 11 of different sizes for motor vehicle license plates 10 having other formats.

The method according to the invention is explained in the following text with reference to the above-described apparatus:

In a controller (not shown in the figures) of the handling device 27, in particular the rotary drives 33 thereof, of the linear drive 37 and of the removal conveyor 22, the respective individual character sequence is input for the motor vehicle license plate 10 to be produced. Usually, two motor vehicle license plates 10 having the same character sequence are required. These can be produced at the same time with the shown apparatus having two embossing presses 23. The method is explained on the basis of this typical case.

On the basis of the character sequence input in the electronic memory, the required embossing tools 13 are removed from the magazine 12 by the handling device 27 and the two tool holders 25 are equipped with the embossing tools 13 in the intended order by the handling device 27. The handling device 27 thus removes two identical embossing tools 13 individually for each character of the character sequence and equips the tool holders 25 on both sides next to the magazine 12 therewith. In the shown exemplary embodiment (to which the invention is not restricted), the character sequence contains six characters, and so six embossing tools 13 located alongside one another are placed on each tool holder 25 by the handling device 27, wherein the mouths 19 of the embossing tools 13 on the two opposite tool holders 25 face one another. To this end, the embossing tools 13 on the one tool holder 25 are placed on the other tool holder 25 by the handling device 27 in a mirror-inverted manner with respect to the embossing tools 13 by rotation of the grasping means 28 through 180° about a vertical central rotation axis.

The handling device 27 can position the embossing tools on the two tool holders 25 such that they are centered with respect to the blanks 11 in such a way that the embossing tools 13 emboss the characters into the respective blank 11 at the desired location. It is also conceivable for the handling device 27 to position the embossing tools 13 on the tool holders 25 in a centered manner or at spacings specified by the controller. These spacings are then calculated by the controller such that, depending on the number of characters in a character sequence, the characters are distributed regularly on that region of each blank 11 that is available for embossing, and so the characters can be embossed into the motor vehicle license plates at preferably regular spacings.

The handling device 27 furthermore places the blanks 11 on the blank holders 26 on both sides of the magazine 12. This again takes place in a mirror-inverted manner, to which end, if appropriate, the blank 11 for a blank holder 26 is rotated in a horizontal plane. In the exemplary embodiment shown, such rotation of the blanks 11 is not necessary, because the blanks 11 are stacked the other way round, namely rotated through 180° in a horizontal plane, in the two stores 20 on one side of the removal conveyor 22, compared with those in the stores 22 on the other side of the removal conveyor 22 (FIGS. 1 and 4).

The handling device 27 deposits the blanks 11 between the two stops 36 of each blank holder 26, and so the blanks 11 are positioned by the respective handling device 27 in a defined relative position, as seen in the longitudinal direction, with respect to the embossing tools 13 in the tool holders 25 on the blank holders 26. The spacing of the stops 36 can be changed by the linear drive 37, in order to adapt them to differently sized blanks 11 for motor vehicle license plates 10 of other formats. The linear drive 37 can also serve to displace the respective blank 11 in the longitudinal direction with respect to the embossing tools 13 on or in each blank holder 26 and thus to center it with respect to the embossing tools 13. In this case, it may be unnecessary to center the blanks 11 on or in the blank holders 26 by way of the handling device 27.

Once all of the embossing tools 13 have been placed on the tool holders 25 and the blanks 11 have been placed on the blank holders 26 by the handling device 27, and the blanks 11 have been oriented with respect to the embossing tools 13 by the handling device 27 and/or the linear drives 37, the blanks 11 are pushed from the blank holders 26, transversely to the longitudinal direction of the blanks 11, through the open mouths 19 and into the embossing tools 13 by linear drives (not shown). The characters of the character sequence of each embossing press 23 are then embossed into the blanks 11 by the embossing tools 13 and as a result the individual motor vehicle license plates 10 are produced. Depending on the configuration of the embossing presses 23, it may be provided for the linear drives to introduce the tool holders 25 having the embossing tools 13 and the blanks 11 inserted therein into the respective embossing press 23.

After the motor vehicle license plates 10 have been embossed, the tool holders 25 having the embossing tools 13 and the embossed motor vehicle license plates are removed from the embossing presses 23 by the same linear drives and the finished motor vehicle license plates 10 are pulled out of the embossing tools 13 and onto the blank holders 26. The finished embossed motor vehicle license plates 10 are then removed one by one from the blank holder 26 by the handling device 27 and placed on the removal conveyor 22 which transports the finished identification plates out of the apparatus. Furthermore, the handling device 27 removes the embossing tools 13 used to emboss the motor vehicle license plates 10 from the tool holders 25 and deposits them one by one in the magazine 12 either in an intended order or in any desired order stored in the controller. If appropriate, it is possible to provide for the handling device 27 to remove from the tool holders 25 only those embossing tools 13 which are not needed for the next motor vehicle license plate 10 which is to be produced and has an only partly different character sequence. Then, the embossing tools for identical characters on the next motor vehicle license plates 10 can remain on the tool holders 25 and optionally be transposed and/or moved into a different position on the tool holder 25 by the handling device 27.

The apparatus according to the invention and the method according to the invention are suitable not only for the above-described production of motor vehicle license plates 10, but also for the production of other identification plates having an individual sequence of characters and/or symbols or only an individual symbol or only one character.

### LIST OF REFERENCE SIGNS

10 Motor vehicle license plate
11 Blank
12 Magazine
13 Embossing tool
14 Holder
15 Top part
16 Bottom part
17 Transverse edge
18 Transverse edge
19 Mouth
20 Store
21 Retaining rod
22 Removal conveyor
23 Embossing press
24 Transverse side
25 Tool holder
26 Blank holder
27 Handling device
28 Grasping means
29 Parallelogram arm
30 Rotation axis
31 Rotation axis
32 Pivot arm
33 Rotary drive
34 Ceiling plane
35 Frame
36 Stop
37 Linear drive

1. A method for producing embossed identification plates, in particular motor vehicle license plates (10), wherein embossing tools (13) are assembled individually with characters corresponding to the identification plate to be embossed, a blank (11) of the identification plate is assigned to the embossing tools (13) and the characters are embossed into the identification plate by the embossing tools (13) in at least one embossing device, comprising removing the embossing tools (13) that are required for the identification plate in each case to be embossed from a magazine (12) and assigning the embossing tools (13) to at least one tool holder (25) by a handling device (27) in the sequence provided.

2. The method as claimed in claim 1, further comprising positioning the embossing tools (13) on the respective tool holder (25) by the handling device (27), in particular orienting the embossing tools (13) in a desired relative position with respect to the blank (11), in a computationally determined relative position with respect to the blank (11), by the handling device (27).

3. The method as claimed in claim 1, further comprising removing a respective blank (11) from at least one store (20) and positioning the respective blank (11) alongside the tool holder (26) on in each case one blank holder (26) arranged adjacently to the tool holder (25), by the handling device (27).

4. The method as claimed in claim 1, further comprising introducing the respective blank (11) into the embossing tool (13) by a transporting device.

5. The method as claimed in claim 4, further comprising, before being introduced into the embossing tool (13), positioning the respective blank (11) on the relevant tool holder (25) in relation to the embossing tools (13), by the handling device (27) and/or the transporting device.

6. The method as claimed in claim 4, further comprising transporting the tool holder (25) assigned to the transporting device, with the embossing tools (13) located on said tool holder (25) and the blank (11) inserted into the embossing tools (13) on the relevant tool holder (25), into the embossing device and after embossing transporting the tool holder (25) out again by the transporting device.

7. An apparatus for producing embossed identification plates, in particular motor vehicle license plates, having at least one magazine (12) for a stock of embossing tools (13), at least one store (20) for blanks (11) of the identification plate to be produced, and at least one embossing press (23) having in each case one tool holder (25) assigned thereto, by comprising a handling device (27) which serves at least to place embossing tools (13), which are required for embossing each identification plate, on the tool holder (25) provided therefor.

8. The apparatus as claimed in claim 7, wherein the handling device (27) is configured in the manner of a robot.

9. The apparatus as claimed in claim 7, wherein the handling device (27) has at least one multiaxially movable grasping means (28).

10. The apparatus as claimed in claim 9, wherein the handling device (27) has at least one grasping means (28) that is movable in three-dimensional space.

11. The apparatus as claimed in claim 9, that wherein the handling device (27) has a plurality of arms that are movable about in each case one rotation axis and have a spatial parallelogram linkage, wherein the arms act in an articulated manner on the grasping means (28).

12. The apparatus as claimed in claim 11, wherein the grasping means (28) is movable in three-dimensional space by the movable arms, while retaining the orientation of its longitudinal center axis.

13. The apparatus as claimed in claim 7, further comprising a blank holder (26) for in each case one blank (11), the blank holder (26) being provided next to each tool holder (25), said blank holder (26) being assigned to the handling device (27) such that in each case one blank (11) can be deposited by the handling device (27) on the relevant blank holder (26) in the intended relative position with respect to the embossing tools (13) on tool holders (25) assigned to the blank holder (26).

14. The apparatus as claimed in claim 13, wherein the respective blank holder (26) has at least one stop (36) for positioning the respective blank (11) on the blank holder (26).

15. The apparatus as claimed in claim 13, wherein the respective blank holder (26) is configured to displace the blank (11) located thereon in its longitudinal direction with respect to the tool holder (25) which is assigned to the relevant blank (11) and has the embossing tools (13).

16. The apparatus as claimed in claim 8, wherein the robot is a delta robot.
